(19) United States
(12) Patent Application Publication
(10) Pub. No.: US 2005/0169130 A1
(43) Pub. Date: Aug. 4, 2005

(54) Method and apparatus of seek end polarity detection for optical disk drive

(75) Inventor: Chen-Hsing Lo, Taipei (TW)

Correspondence Address: BRUCE H. TROXELL, SUITE 1404, 5205 LEESBURG PIKE, FALLS CHURCH, VA, 22041, US

(73) Assignee: Ali Corporation

(21) Appl. No.: 10/878,999

(22) Filed: Jun. 30, 2004

(30) Foreign Application Priority Data
Feb. 3, 2004 (TW) 93102347

(51) Int. Cl. G11B 7/00

(52) U.S. Cl. 369/44.29; 369/44.25; 369/44.28

(57) ABSTRACT

The present invention discloses a method and apparatus of seek end polarity detection for an optical disk drive. The method comprises the steps of providing a horizontal level between the peak and the trough of the tracking error signal when the tracking error signal is used to determine the polarity of the tracking error; and determining the tracking error polarity by examining whether or not the adjacent waveform level is smaller or larger than the horizontal level after the tracking error signal passes through the horizontal level.

### 1. FIELD OF THE INVENTION

The present invention relates to a method and apparatus of seek end polarity detection for an optical disk drive, and more particularly, to a method and apparatus of seek end polarity detection for an optical disk drive by providing a horizontal level to the tracking error signal as the base of the seek end polarity detection.

### 2. BACKGREVOLUTION OF THE INVENTION

When an optical disk drive reads data from an optical disk therein, the optical pickup head of the optical disk drive moves from tracks to tracks for accessing data from different tracks of the optical disk. Therefore, the optical pickup head will perform a seek action to move the laser dot emitted from the pickup head between different tracks of the optical disk such that data stored on different tracks of the optical disk can be accessed successfully. In a DVD-ROM optical disk drive, data is being written into grooves of the DVD-ROM disk therein.

Please refer to FIG. 1, which is a block diagram showing the tracking architecture of a conventional optical disk drive. In the tracking architecture 100 of an optical disk drive, a subtractor 110 is used to integrate the signals outputted respectively from a velocity profile 115 and a speed calculator 120 into a velocity error signal 125, and the seek controller 130 controls a driver 135 to move an optical pickup head 140 according to the velocity error signal 125.

If the optical pickup head 140 takes an action such as seeking a track, the optical pickup head will issue a plurality of signals representing its read/write state, and send such signals to a pre-amplifier 145. The pre-amplifier 145 will generate a new tracking error signal 150 and a tracking error zero cross (TEZC) signal 155 according to the plural signals outputted from the optical pickup head 140. A track controller 153 controls the seek action of the optical pickup head 140 according to the tracking error signal 150; and the speed calculator 120 outputs a zero cross speed signal (ZCSPD) 169 according to the tracking error zero cross signal 155. The subtractor 110 generates the velocity error signal 125 by subtracting the ZCSPD signal 169 with the signal received from the velocity profile 115, and the resulting velocity-error signal 125 is used by the seek controller 130 as a seek control signal for the optical pickup head 140.

In a DVD-ROM optical disk drive, the target track at seek end is a groove since data is written onto the grooves of the DVD-ROM disk. Hence, it is required to have a correct polarity of tracking error signal 125 of the target track for the DVD-ROM optical disk drive to perform the tracking action at a seek end.

The reasons reside on that the tangential slope for the tracking error signals of the corresponding groove and land are reversed at a seek end. To match the tracking error signals of the corresponding groove and land with the negative tracking feedback of a close circuit control, the tracking error signal corresponding to the position of the groove is defined as a positive polarity and that corresponding to the position of the land is defined as a negative polarity.

However, when the operating platform for the seek action shifts from the DVD-ROM drive to the DVD-RAM drive, the writable area of the DVD-RAM optical disk also includes the grooves and lands, and thus the target track of a DVD-RAM optical disk drive can be either a groove or a land at a seek end.

Therefore, if the target track is located at a land (i.e. the position of negative polarity of the tracking error signal), the close circuit control of the negative tracking feedback needs to invert the phase of the tracking error signal.

However, current DVD-RAM drive uses the seek end mechanism designed for the DVD-ROM, such that current DVD-RAM drive applies a tracking control whose polarity is designed to end a seek action on a groove. However, the landing position of the DVD-RAM drive may be either a land or a groove, and the polarity of the tracking error signal representing the land and that representing the groove are exact the opposite. In this regard, the result of a tracking control in the DVD-RAM drive can be either a positive result or a negative result.

Please refer to FIGS. 2A and 2B, which are schematic diagrams showing respectively a jump outer tracking error signal of DVD-ROM drive and a jump inner tracking error signal of DVD-ROM drive. When the DVD-ROM drive perform a jump outer seek action, the tracking error signal is as shown in FIG. 2A. The tracking error signal is equivalent to the position of the track of the responding disk. If the tangential slope of the waveform of the tracking error signal is positive representing the polarity is positive, the target track of the DVD-ROM disk falls into a groove of the disk, and if the tangential slope of the waveform of the tracking error signal is negative representing the polarity is negative, the target track of the DVD-ROM disk falls into a land of the disk, that the target track is also the area for reading and writing data.

On the other hand, When the DVD-ROM drive perform a jump inner seek action, the tracking error signal is as shown in FIG. 2B. The tracking error signal is exactly symmetrical to the tracking error signal as depicted in FIG. 2A. That is, if the tangential slope of the waveform of the tracking error signal is positive representing the polarity is negative, the target track of the DVD-ROM disk falls into a land of the disk, and if the tangential slope of the waveform of the tracking error signal is negative representing the polarity is positive, the target track of the DVD-ROM disk falls into a groove of the disk.

At last, the DVD-ROM disk must move to a correct target track to finish a seek action successfully.

However, if it is unable to determine the polarity of the tracking error signal at a seek end of the DVD-RAM disk drive, a serious slip may occur due to the seek ends to an incorrect land or groove, and thus the seek action cannot be ended successfully.

In view of the description above, the present invention provides a method and apparatus of seek end polarity detection for an optical disk drive capable of detecting the polarity of the tracking error signal (therefore capable of determining the target track at seek end is a land or a groove). If the polarity is negative (i.e. the target track at a seek end is a land), then its phase is inverted, so that the tracking error signal complies with the tracking control and the DVD-RAM drive can successfully enter into the tracking when the seek ends without causing a slip.

### SUMMARY OF THE INVENTION

The primary objective of the present invention is to provide a method of seek end polarity detection for an optical disk drive, comprising the step of: providing a horizontal level between the peak and trough of a tracking error signal before making an evaluation to determine the direction of a seek action and the polarity of the tracking error signal; and determining the polarity of the tracking error signal (i.e. the target track is a land or a groove) according to the adjacent waveform level following the horizontal level by comparing the waveform level to the horizontal level.

In a preferred embodiment of the invention, such horizontal level further includes a positive horizontal level and a negative horizontal level Therefore, the corresponding determination mechanism further includes the following four situations:

(1) If the optical disk drive is performing a jump outer seek action and the waveform level adjacent to negative horizontal level is smaller than the same, the polarity of the tracking error signal is determined as positive (i.e. the target track falls on a groove).

(2) If the optical disk drive is performing a jump outer seek action and the waveform level adjacent to positive horizontal level is larger than the same, the polarity of the tracking error signal is determined as negative (i.e. the target track falls on a land).

(3) If the optical disk drive is performing a jump inner seek action and the waveform level adjacent to positive horizontal level is larger than the same, the polarity of the tracking error signal is determined as positive (i.e. the target track falls on a groove).

(4) If the optical disk drive is performing a jump inner seek action and the waveform level adjacent to negative horizontal level is smaller than the same, the polarity of the tracking error signal is determined as negative (i.e. the target track falls on a land).

The present invention also provides an apparatus of seek end polarity detection for an optical disk drive, comprising: a subtractor, a control unit, a first electronic switch, an optical pickup head, a driver, a preamplifier, and a speed calculator. The subtractor receives a speed curve signal and a zero cross speed signal so as to output a velocity error signal. The control unit further comprises a track controller, a seek controller, and a seek end polarity detector. The track controller receives a tracking error signal to output a control signal. The seek end polarity detector receives the tracking error signal and seek direction and outputs a polarity signal to the seek controller.

The first electronic switch outputs the command signal received from the track controller while switching to connect with the track controller, and outputs the signal received from the seek controller while switching to connect with the seek controller. The optical pickup head is used to read and write data onto a DVD-RAM disk. The driver receives a signal outputted by the electronic switch to control the the optical pickup head. The pre-amplifier receives a signal outputted from the optical pickup head so as to output a tracking error signal and a tracking error zero cross signal. The speed calculator receives the tracking error zero cross signal to output a zero cross speed signal.

In a preferred embodiment of the present invention, the seek end polarity detector further comprises a seek direction/target track selector, a positive level detector, a negative level detector, and a second electronic switch. The seek direction/target track selector receives either a jump inner seek signal or a jump outer seek signal for controlling the optical pickup head of the DVD-RAM drive to perform a seek action in order to output a control signal. The positive level detector provides a positive level for the tracking error signal and detects the maximum point of the tracking error signal after the tracking error signal passes through the positive level. The negative level detector provides a negative level for the tracking error signal and detects the minimum point after the tracking error signal passes through the negative level. The second electronic switches receives a tracking error signal and output the tracking error signal to either the positive level detector or the negative level detector according to the control signal.

In summation of the description above, the present invention provides a method and apparatus of seek end polarity detection for an optical disk drive, and provides a horizontal level to determine the polarity of the tracking error signal according to the seek direction and the set target track. If the polarity is negative, the phase of the tracking error signal is inverted, so that the tracking error signal complies with the negative feedback of the tracking control and the DVD-RAM drive can successfully enter into the tracking control when the seek ends and the slip will not happen.

### BRIEF DESCRIPTION OF THE DRAWINGS

FIG. 1 is a block diagram showing the tracking architecture of a conventional optical disk drive.

FIGS. 2A and 2B are schematic diagrams showing respectively a jump outer tracking error signal of DVD-ROM drive and a jump inner tracking error signal of DVD-ROM drive.

FIGS. 3A to 3D are schematic diagrams illustrating a method of seek end polarity detection for an optical disk drive according to a preferred embodiment of the present invention.

FIG. 4 is a schematic diagram showing an apparatus of seek end polarity detection for an optical disk drive according to a preferred embodiment of the present invention.

FIG. 5 is a schematic diagram showing a seek end polarity detector according to a preferred embodiment of the present invention.

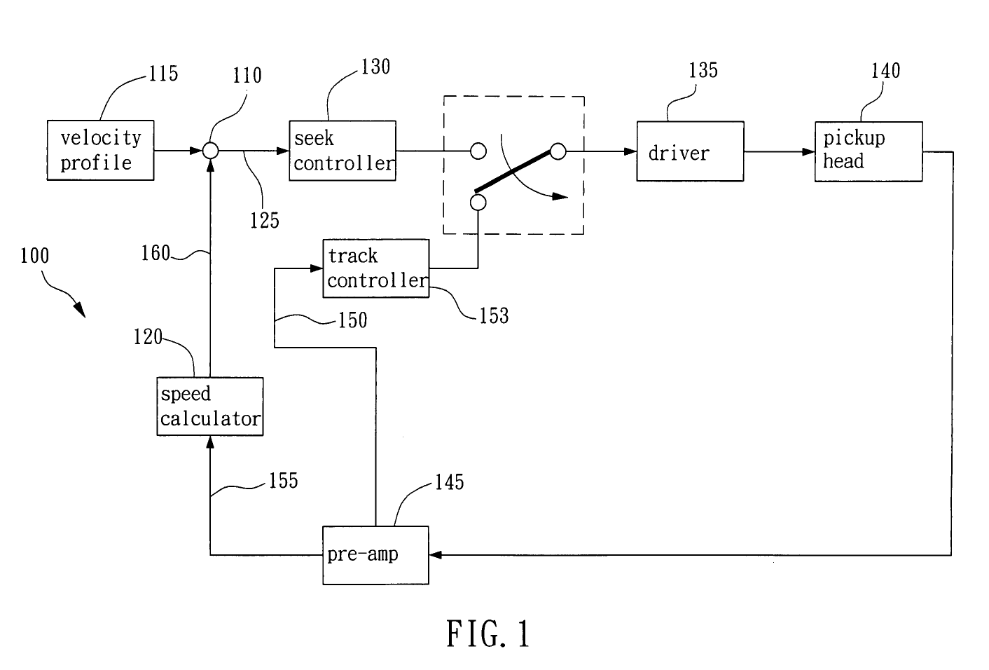

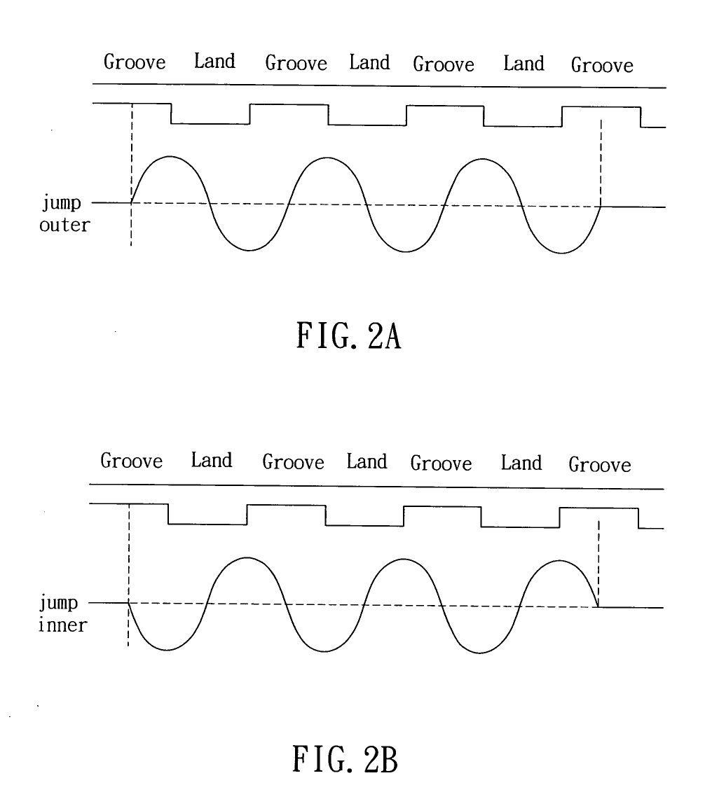

### DESCRIPTION OF THE PREFERRED EMBODIMENT

To make the esteemed review committee can further understand and recognize the present invention, a detailed description in accordance with several accompanying diagrams are presented as following.

To determine the polarity of the tracking error signal of a target track at a seek end, the DVD-RAM drive of the present invention uses the tracking error signal to determine the track number of the seek action, and provides a horizontal level for the tracking error signal when the seek action lands on a track in front of the target track, and such horizontal level will appear between the peak and trough of the tracking error signal. After the tracking error signal passes through the horizontal level, the polarity can be determined by comparing the waveform level adjacent to the horizontal level with the same.

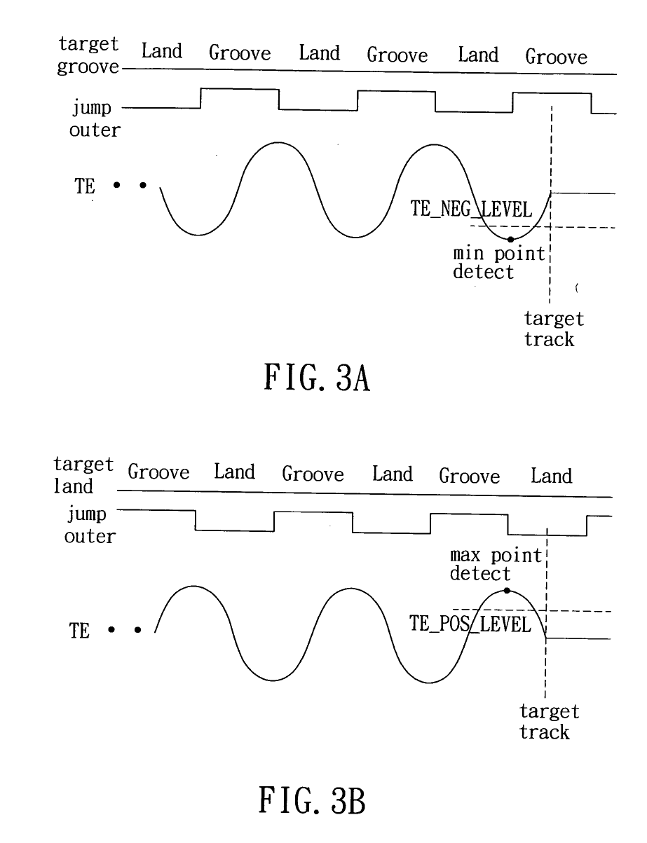

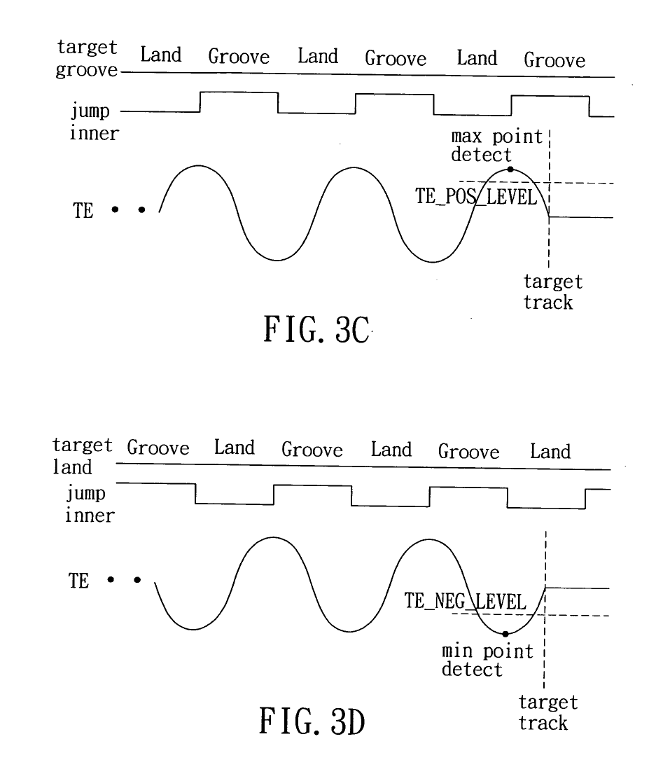

Please refer to FIGS. 3A to 3D, which are schematic diagrams illustrating a method of seek end polarity detection for an optical disk drive according to a preferred embodiment of the present invention. In FIG. 3A, the DVD-RAM drive performs a jump outer seek action according to the tracking error signal (TE), and the target track is a groove. To determine the the polarity of a tracking error signal corresponding to the target track at the seek end, a preferred embodiment of the invention provides a negative horizontal level for the DVD-RAM drive arranged between the peak and the trough of the tracking error signal at a track in front of the target track. Since the target track is a groove, the negative horizontal level will be disposed proximate to the position of the trough. Then, the waveform level of the tracking error signal passing such negative horizontal level is detected and checked whether or not such waveform level is smaller or larger than the negative horizontal level. If the detected waveform level, such as the minimum point of the trough is smaller than the negative horizontal level, then the target track is confirmed as a groove, and the polarity of the tracking error signal corresponding to the target track is positive.

Please refer to FIG. 3B. In FIG. 3B, the DVD-RAM drive performs a jump outer seek action according to the tracking error signal (TE), and the target track is a land. Similarly, a positive horizontal level is provided for the DVD-RAM drive which is arranged between the peak and the trough of the tracking error signal at a track in front of the target track. Since the target track is a land, such positive horizontal level will be disposed proximate to the position of the peak. Then, the waveform level of the tracking error signal passing such positive horizontal level is detected and checked whether or not such waveform level is smaller or larger than the positive horizontal level. If the detected waveform level, such as the maximum point of the peak is larger than such positive horizontal level, then the target track is confirmed as a land, and the polarity of the tracking error signal corresponding to the target track is negative.

In FIG. 3C, the DVD-RAM drive performs a jump inner seek action according to the tracking error signal (TE), and the target track is a groove. Such tracking error signal TE is exactly symmetrical to the tracking error signal TE as depicted in FIG. 3A. Similarly, a positive horizontal level is provided for the DVD-RAM drive which is arranged between the peak and the trough of the tracking error signal at a track in front of the target track. Since the target track is a groove, such positive horizontal level will be disposed proximate to the position of the peak. Then, the waveform level of the tracking error signal TE passing such positive horizontal level is detected and checked whether or not such waveform level is smaller or larger than the positive horizontal level. If the detected waveform level, such as the maximum point of the peak is larger than such positive horizontal level, then the target track is confirmed as a groove, and the polarity of the tracking error signal corresponding to the target track is positive.

In FIG. 3D, a negative horizontal level is provided for the DVD-RAM drive which is arranged between the peak and the trough of the tracking error signal at a track in front of the target track. Since the target track is a groove, such negative horizontal level will be disposed proximate to the position of the trough. Then, the waveform level of the tracking error signal TE passing such negative horizontal level is detected and checked whether or not such waveform level is smaller or larger than the negative horizontal level. If the detected waveform level, such as the minimum point of the trough is smaller than such negative horizontal level, then the target track is confirmed as a land, and the polarity of the tracking error signal corresponding to the target track is negative.

With the determination of the corresponding polarity of the tracking error signal when the seek action ends, the polarity required for ending the seek can be obtained correctly, and thus the seek action can be ended successfully. If the corresponding polarity of the tracking error signal after the seek action is correct, a tracking error signal can be provided for the track controller as a negative feedback control.

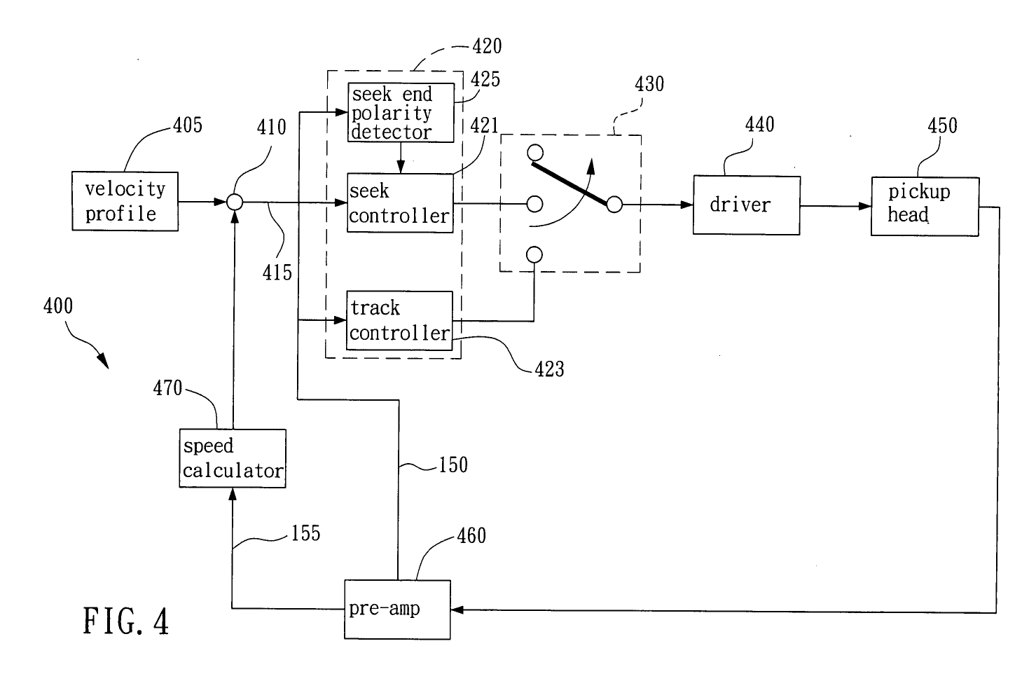

The present invention further provides an apparatus of seek end polarity detection for an optical disk drive. Please refer to FIG. 4, which is a schematic diagram showing an apparatus of seek end polarity detection for an optical disk drive according to a preferred embodiment of the present invention. In FIG. 4, such apparatus 400 comprises a velocity profile 405, a subtractor 410, a control unit 420, an electronic switch 430, an optical pickup head 450, a pre-amplifier 460, and a speed calculator 470.

Moreover, the control unit 420 further comprises a seek end polarity detector 425 in addition to a seek controller 421 and a track controller 423. Therefore, the seek end polarity detector 425 can determine the polarity of the tracking error signal corresponding to the target track of the seek controller 421 according to a tracking error signal 150 outputted from the pre-amplifier 460, so that the seek action can end on the correct polarity of the tracking error signal 150 and enter into the tracking control successfully. Further, the seek end polarity detector 425 can be installed directly in the seek controller 421.

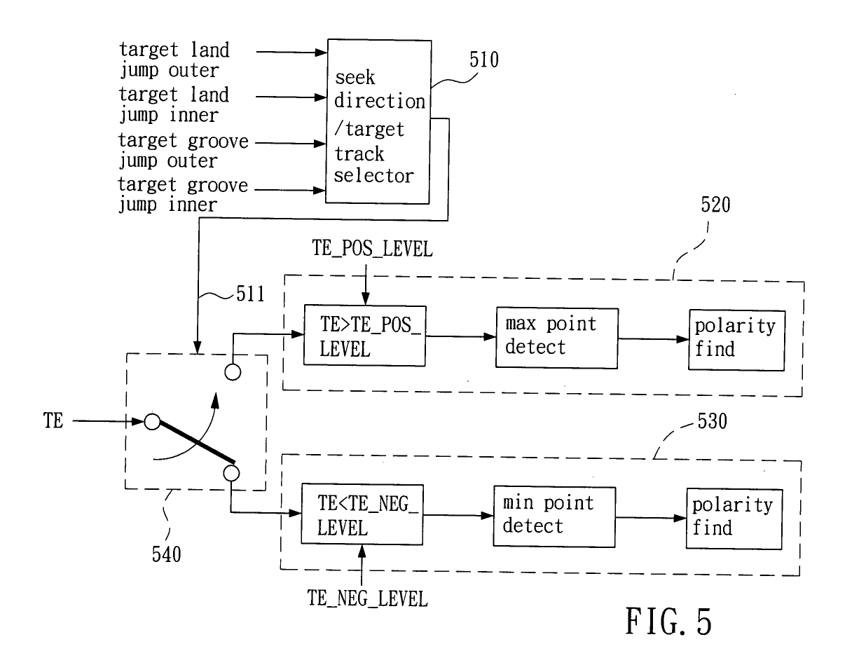

As seen in FIGS. 3A to 3D, there are four situations for a DVD-RAM drive to seek a DVD-RAM drive, including the target track is a groove with jump outer and jump inner, and the track is a land with jump outer and jump inner. However, the method of seek end polarity detection for an optical disk drive is the same for the two situation, which are the target track is groove with jump outer and the target track is land with jump inner, and also the method of seek end polarity detection for an optical disk drive is the same for the two situation, which are the target track is groove with jump inner and the target track is land with jump outer. Therefore, the determination mechanism for determining the polarity of the tracking error signal TE inside the seek end polarity detector 425 can be simplified as shown in FIG. 5.

Please refer to FIG. 5, which is a schematic diagram showing a seek end polarity detector according to a preferred embodiment of the present invention. Such seek end polarity detector 425 comprises a seek direction/target track selector 519, a positive level detector 520, a negative level detector 530, and an electronic switch 540. The seek direction and target track selector 510 can receive a signal of controlling the seek action and the target track of the pickup head in order to output a control signal 511. The control signal 511 controls the electronic switch 540 to switch either to output the tracking error signal TE to the positive level detector 520 or to the negative level detector 530.

If the target track is a groove and the seek action is performed from inner tracks to outer tracks as well as if the target track is a land and the seek action is performed from outer tracks to inner tracks, the tracking error signal TE received by the electronic switch 540 is outputted to the negative level detector 520. On the other hand, if the target track is a groove and the seek action is performed from outer tracks to inner tracks as well as if the target track is a land and the seek action is performed from inner tracks to outer tracks, the tracking error signal TE received by the electronic switch 540 is outputted to the positive level detector 520. After the negative level detector 530 receives the tracking error signal TE, a negative horizontal level set from the outside is provided for the tracking error signal TE, and the position of the minimum point is detected after the tracking error signal TE passes through such negative horizontal level, and then the polarity of the tracking error signal TE of the target track on where the seek action lands can be found according to the method as shown in FIGS. 3A and 3C. After the positive detector 520 receives the tracking error signal TE, a positive level set from the outside is provided for the tracking error signal TE, and the position of the maximum point is detected after the tracking error signal TE passes through such positive horizontal level, and then the polarity of the tracking error signal TE of the target track on where the seek action lands can be found according to the method as shown in FIGS. 3B and 3D.

In summation of the description above, the present invention discloses a method and apparatus of seek end polarity detection for an optical disk drive. By the seek direction and target track setup as well as a horizontal level provided for the tracking error signal, the polarity of the target track of such tracking error signal can be detected after the seek action. The present invention allows the DVD-RAM drive to end the seek action successfully and enters into the tracking, and thus the slip will not happen.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A method of seek end polarity detection for an optical disk drive, comprising the step of:
providing a horizontal level, arranged between the peak and trough of a tracking error signal, while making an evaluation to determine the polarity of the tracking error signal according to the tracking error signal; and
determining the polarity of the tracking error signal according to an adjacent waveform level following the horizontal level by comparing the waveform level to the horizontal level.

2. The method of claim 1, wherein said horizontal level further comprises a positive horizontal level and a negative horizontal level.

3. The method of claim 2 further comprising:
determining the polarity of the tracking error signal as positive if the seek action of the optical disk drive being performed from inner tracks to outer tracks and the adjacent waveform level is smaller than the negative horizontal level after the tracking error signal passes through the negative horizontal level.

4. The method of claim 3 further comprising:
determining the polarity of the tracking error signal as positive if the seek action of the optical disk drive being performed from inner tracks to outer tracks and the adjacent waveform level is larger than the positive horizontal level after the tracking error signal passes through the positive horizontal level.

5. The method of claim 4 further comprising:
determining the polarity of the tracking error signal as positive if the seek action of the optical disk drive being performed from outer tracks to inner tracks and the adjacent waveform level is larger than the positive horizontal level after the tracking error signal passes through the positive horizontal level.

6. The method of claim 5 further comprising:
determining the polarity of the tracking error signal as positive if the seek action of the optical disk drive being performed from outer tracks to inner tracks and the adjacent waveform level is smaller than the negative horizontal level after the tracking error signal passes through the negative horizontal level.

7. The method of claim 2 further comprising:
determining the polarity of the tracking error signal as positive if the adjacent waveform level is larger than the positive horizontal level after the tracking error signal passes through the positive horizontal level; and
determining the polarity of the tracking error signal as positive if the adjacent waveform level is smaller than the negative horizontal level after the tracking error signal passes through the negative horizontal level.

8. The method of claim 7 further comprising:
determining the polarity of the tracking error signal as positive if the adjacent peak level is larger than the positive horizontal level after the tracking error signal passes through the positive horizontal level; and
determining the polarity of the tracking error signal as positive if the adjacent trough level is smaller than the negative horizontal level after the tracking error signal passes through the negative horizontal level.

9. The method of claim 1 further comprising:
providing the horizontal level to a waveform of the tracking error signal on a track in front of a target track.

10. An apparatus of seek end polarity detection for an optical disk drive, comprising:
a velocity profile for generating a speed curve signal;
a subtractor, for receiving said speed curve signal and a zero cross speed signal to output a speed error signal;
a control unit, further comprising:
a track controller for receiving a tracking error signal to output a control signal;
a seek end polarity detector for receiving and detecting a polarity of said tracking error signal to output a polarity determination signal of said tracking error polarity;
a seek controller, for receiving said tracking control signal and said polarity determination signal to output a control signal;
a first electronic switch, for switching a signal outputted from said track controller and said seek controller;
an optical pickup head, for reading and writing data on a disk in said optical disk drive;
a driver, for receiving a signal outputted from said electronic switch to control the movement of said optical pickup head;
a pre-amplifier, for receiving a signal outputted from said optical pickup head to output said tracking error signal and a tracking error zero cross signal; and
a speed calculator, for receiving said tracking error zero cross signal to output a zero cross speed signal.

11. The apparatus of claim 10 further comprising:
a seek direction/target track selector, for receiving a signal for controlling said optical disk drive to control said optical pickup head to jump from outer tracks to inner tracks to output a control signal;
a positive level detector, for providing a positive horizontal level for said tracking error signal and detecting the position of the highest point after said tracking error signal passes through said positive horizontal level;
a negative level detector, for providing a negative horizontal level for said tracking error signal and detecting the position of the lowest point after said tracking error signal passes through said negative horizontal level; and
a second electronic switch, for receiving said tracking error signal and switching the output of said tracking error signal selectively to said positive level detector and said negative level detector according to said control signal.
